(19) United States
(12) Patent Application Publication
(10) Pub. No.: US 2026/0246286 A1
(43) Pub. Date: Aug. 20, 2026

(54) DC POWER SUPPLY DEVICE

(71) Applicant: APh ePower Co., Ltd., Kaohsiung City (TW)

(72) Inventors: Hsiu-Hsien Su, Kaohsiung City (TW); Yi Jun Lin, Kaohsiung City (TW); Kuan-Chieh Huang, Kaohsiung City (TW)

(73) Assignee: APh ePower Co., Ltd., Kaohsiung City (TW)

(21) Appl. No.: 19/461,747

(22) Filed: Jan. 28, 2026

(30) Foreign Application Priority Data
Feb. 14, 2025 (TW) 114105550

(51) Int. Cl. H02J 7/50; H02J 1/10; H02J 7/34; H02J 7/68; H02J 7/90

(52) U.S. Cl. CPC H02J 7/585; H02J 1/106; H02J 7/34; H02J 7/68; H02J 7/933; H02J 2207/20

(57) ABSTRACT

A DC power supply device is provided. The DC power supply device includes a DC power bus, a first detection circuit, a second detection circuit, battery modules and a management circuit. The first detection circuit detects an external power source entering the DC power bus. The second detection circuit detects a load status on the DC power bus. The plurality of battery modules is respectively assembled to the DC power bus in a detachable manner. When the DC power bus does not receive external power source, the management circuit adjusts the power supply quantity of assembled battery modules assembled the DC power bus to according to the load status.

### CROSS-REFERENCE TO RELATED APPLICATION

This application claims the priority benefit of Taiwan application serial no. 114105550, filed on February 14, 2025. The entirety of the above-mentioned patent application is hereby incorporated by reference herein and made a part of this specification.

### BACKGROUND

### Technical Field

The disclosure relates to a power supply technology, and more particularly, to a DC power supply device.

### Description of Related Art

Generally speaking, current supply devices may utilize one of an external power source and a single battery module to power a load. However, based on variations in the load power of the load, a single battery module may not satisfy the high power demand of the load. Further, under prolonged use of a single battery module, the lifespan of the battery in the battery module is shortened. The performance of the battery in the battery module is also significantly reduced.

### SUMMARY

The disclosure provides a DC power supply device having a battery module.

In an embodiment of the disclosure, a DC power supply device includes a DC power bus, a first detection circuit, a second detection circuit, a plurality of battery modules, and a management circuit. The first detection circuit is coupled to the DC power bus. The first detection circuit detects an external power source entering the DC power bus. The second detection circuit is coupled to the DC power bus. The second detection circuit detects a load status on the DC power bus. The plurality of battery modules are respectively assembled to the DC power bus in a detachable manner. The management circuit communicates with the first detection circuit, the second detection circuit, and a plurality of assembled battery modules assembled to the DC power bus. In response to the DC power bus not receiving the external power source, the management circuit adjusts a power supply quantity of the plurality of assembled battery modules based on the load status.

Based on the above, the DC power supply device includes a plurality of assembled battery modules assembled to the DC power bus. In response to the DC power bus not receiving the external power source, the management circuit may dynamically adjust the power supply quantity of the plurality of assembled battery modules based on the load status. As such, the lifespan of the battery cells of the plurality of assembled battery modules may be extended. The performance of the battery cells in the battery module is not significantly reduced.

### BRIEF DESCRIPTION OF THE DRAWINGS

FIG. 1 is a schematic diagram of a DC power supply device according to an embodiment of the disclosure.

FIG. 2 is a schematic diagram illustrating an operation of the DC power supply device not receiving the external power source according to an embodiment of the disclosure.

FIG. 3 is a schematic diagram illustrating an operation of the DC power supply device not receiving the external power source according to an embodiment of the disclosure.

FIG. 4 is a schematic diagram illustrating an operation of the DC power supply device receiving the external power source according to an embodiment of the disclosure.

FIG. 5 is a schematic diagram of a battery module according to an embodiment of the disclosure.

FIG. 6 is a schematic diagram of a battery module according to an embodiment of the disclosure.

FIG. 7 is a schematic diagram illustrating an operation of the battery module according to an embodiment of the disclosure.

FIG. 8 is a schematic diagram illustrating an operation of the battery module according to an embodiment of the disclosure.

### DESCRIPTION OF THE EMBODIMENTS

Some embodiments of the disclosure will be described in detail below with reference to the accompanying drawings. The reference numerals cited in the following description, when the same reference numerals appear in different drawings, will be regarded as the same or similar elements. These examples are only a portion of the disclosure and do not disclose all possible embodiments of the disclosure. More precisely, these embodiments are only examples within the scope of the patent application of the disclosure.

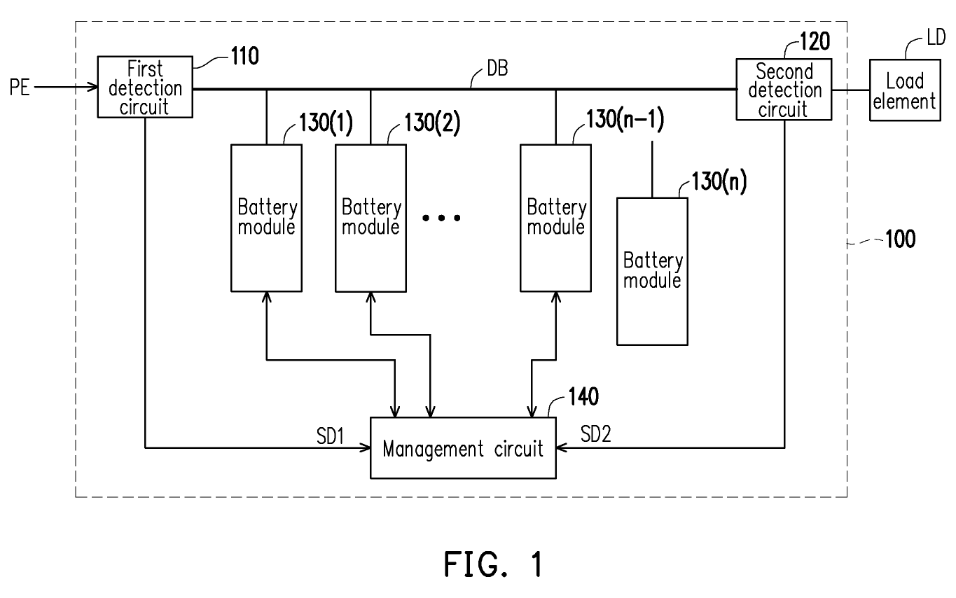

Referring to FIG. 1, FIG. 1 is a schematic diagram of a DC power supply device according to an embodiment of the disclosure. In this embodiment, the DC power supply device 100 includes a DC power bus DB, a first detection circuit 110, a second detection circuit 120, battery modules 130(1) to 130(n), and a management circuit 140. The first detection circuit 110 is coupled to the DC power bus DB. The first detection circuit 110 detects the external power source PE entering the DC power bus. The second detection circuit 120 is coupled to the DC power bus DB. The second detection circuit 120 detects the load status at the DC power bus DB. The battery modules 130(1) to 130(n) are respectively assembled to the DC power bus DB in a detachable manner. In this embodiment, the battery modules 130(1) to 130(n) may be assembled to the DC power bus DB based on actual usage requirements. Taking this embodiment as an example, the battery modules 130(1) to 130(n-1) (or referred to as assembled battery modules 130(1) to 130(n-1)) are assembled to the DC power bus DB. The battery module 130(n) is not assembled to the DC power bus DB.

Based on actual usage requirements, the quantity of assembled battery modules may be adjusted.

In this embodiment, the management circuit 140 communicates with the first detection circuit 110, the second detection circuit 120, and the battery modules 130(1) to 130(n-1) assembled to the DC power bus. The management circuit 140 is able to determine the external power source PE input to the DC power bus DB based on the detection result of the first detection circuit 110. The management circuit 140 is able to determine the load status based on the detection result of the second detection circuit 120. In response to the DC power bus DB not receiving the external power source PE, the management circuit 140 adjusts the power supply quantity of the battery modules 130(1) to 130(n-1) based on the load status.

It is worth mentioning here that the load status may be the load status of the load element LD connected to the DC power bus DB. In response to the DC power bus DB not receiving the external power source PE, the management circuit 140 is able to dynamically adjust the power supply quantity of the battery modules 130(1) to 130(n-1) assembled to the DC power bus DB based on the load status. As such, the lifespan of the battery cells of the battery modules 130(1) to 130(n-1) may be extended. The performance of the battery cells in the battery modules 130(1) to 130(n-1) is not significantly reduced. Further, the battery module 130(n) may be used as a backup battery module.

In this embodiment, the DC power supply device 100 may be applicable to electronic devices, equipment, or electric vehicles. The electronic device may be a portable electronic device or a non-portable electronic device. The electric vehicle may be an electric transportation vehicle that uses at least electricity as a power source.

In this embodiment, the management circuit 140 performs wired communication or wireless communication with the first detection circuit 110, the second detection circuit 120, and the battery modules 130(1) to 130(n-1) assembled to the DC power bus. The management circuit 140 is, for example, a Central Processing Unit (CPU), or other programmable general-purpose or special-purpose Microprocessor, Digital Signal Processor (DSP), programmable controller, Application Specific Integrated Circuits (ASIC), Programmable Logic Device (PLD), or other similar devices or combinations of these devices, which may load and execute computer programs.

Further, in response to one of the battery modules 130(1) to 130(n) malfunctioning, the malfunctioning battery module may be detached from the DC power bus DB for maintenance. As such, the cost of maintenance may be reduced. The convenience of maintenance may be improved.

In this embodiment, the management circuit 140 receives the detection signal SD1 from the first detection circuit 110 and the detection signal SD2 from the second detection circuit 120. The management circuit 140 may determine the external power source PE input to the DC power bus DB based on the detection signal SD1. The management circuit 140 may determine the load status based on the detection signal SD2.

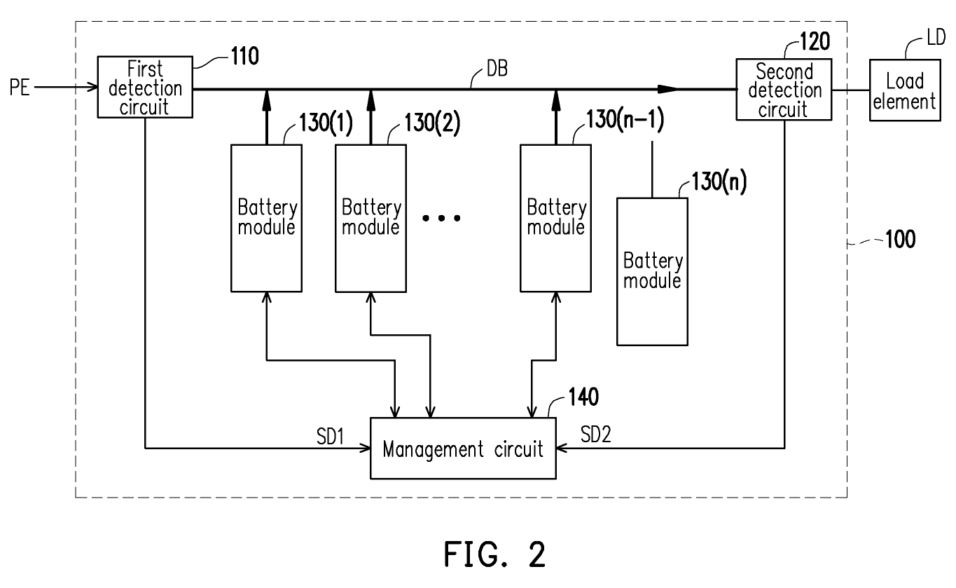

Referring to FIG. 2, FIG. 2 is a schematic diagram illustrating the operation of the DC power supply device not receiving the external power source according to an embodiment of the disclosure. In this embodiment, in response to the DC power bus DB not receiving the external power source PE and the load status indicating a heavy load, the management circuit 140 controls all the battery modules 130(1) to 130(n-1) to power the DC power bus DB.

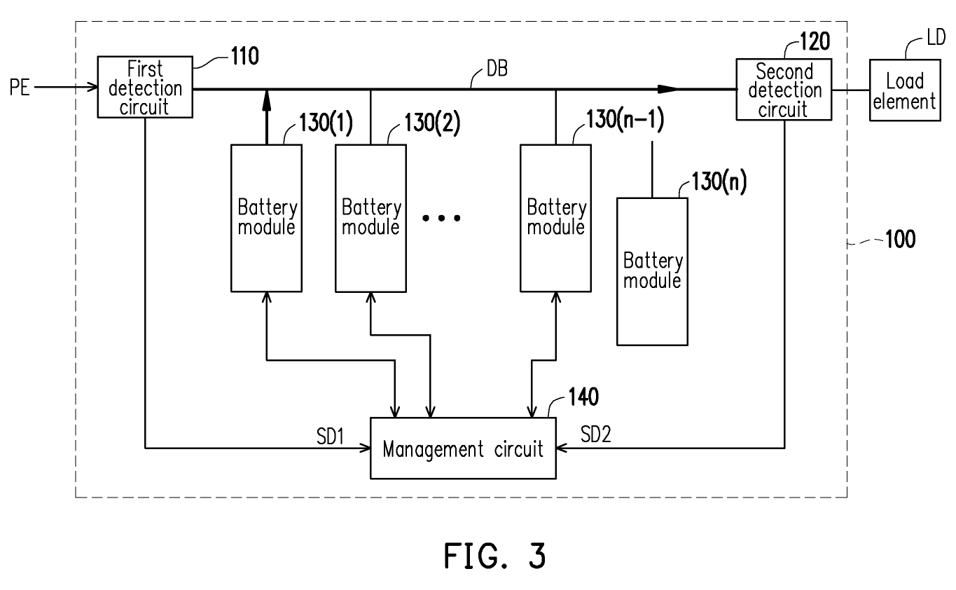

Referring to FIG. 3, FIG. 3 is a schematic diagram illustrating the operation of the DC power supply device not receiving the external power source according to an embodiment of the disclosure. In this embodiment, in response to the DC power bus DB not receiving the external power source PE and the load status indicating a light load, the management circuit 140 controls one of the battery modules 130(1) to 130(n-1) to power the DC power bus DB.

In FIG. 2 and FIG. 3, in response to the load status indicating that the load of the DC power bus DB increases and the DC power bus DB not receiving the external power source PE, the management circuit 140 increases the power supply quantity of the battery modules 130(1) to 130(n-1). For example, in a light load status, the power supply quantity of the battery modules 130(1) to 130(n-1) is equal to 1. In response to the load of the DC power bus DB increasing by a set power difference, the power supply quantity of the battery modules 130(1) to 130(n-1) is equal to 2. In response to the load of the DC power bus DB further increasing by the set power difference, the power supply quantity of the battery modules 130(1) to 130(n-1) is equal to 3, and so on.

In response that the load status indicating that the load of the DC power bus DB decreases and the DC power bus DB not receiving the external power source PE, the management circuit 140 reduces the power supply quantity of the battery modules 130(1) to 130(n-1). For example, in a heavy load status, the power supply quantity of the battery modules 130(1) to 130(n-1) is equal to (n-1). In response to the load of the DC power bus DB decreasing by the set power difference, the power supply quantity of the battery modules 130(1) to 130(n-1) is equal to (n-2). In response to the load of the DC power bus DB further decreasing by the set power difference, the power supply quantity of the battery modules 130(1) to 130(n-1) is equal to (n-3), and so on.

It should be noted that this embodiment may dynamically adjust the power supply quantity of the battery modules 130(1) to 130(n-1) in real time based on the load variation of the DC power bus DB.

For example, the management circuit 140 determines the discharge order of the battery modules 130(1) to 130(n-1) based on the remaining battery of the battery modules 130(1) to 130(n-1). For example, in a light load status, the management circuit 140 communicates with the battery modules 130(1) to 130(n-1) to obtain that the battery module 130(1) has the most remaining battery, and the battery module 130(2) has the second most remaining battery. Thus, the management circuit 140 controls the battery module 130(1) to preferentially power the DC power bus DB. In response to the load increasing, the management circuit 140 controls the battery modules 130(1) and 130(2) to preferentially power the DC power bus DB.

In some embodiments, in response to the DC power bus DB not receiving the external power source PE and the load status indicating a light load, the management circuit 140 controls all the battery modules 130(1) to 130(n-1) to power the DC power bus DB with lower discharge power. As a result, the discharge burden of the battery modules 130(1) to 130(n-1) may be balanced, thereby ensuring that the battery energy is released efficiently and evenly under light load conditions, further extending the lifespan of the battery cells of the battery modules 130(1) to 130(n-1).

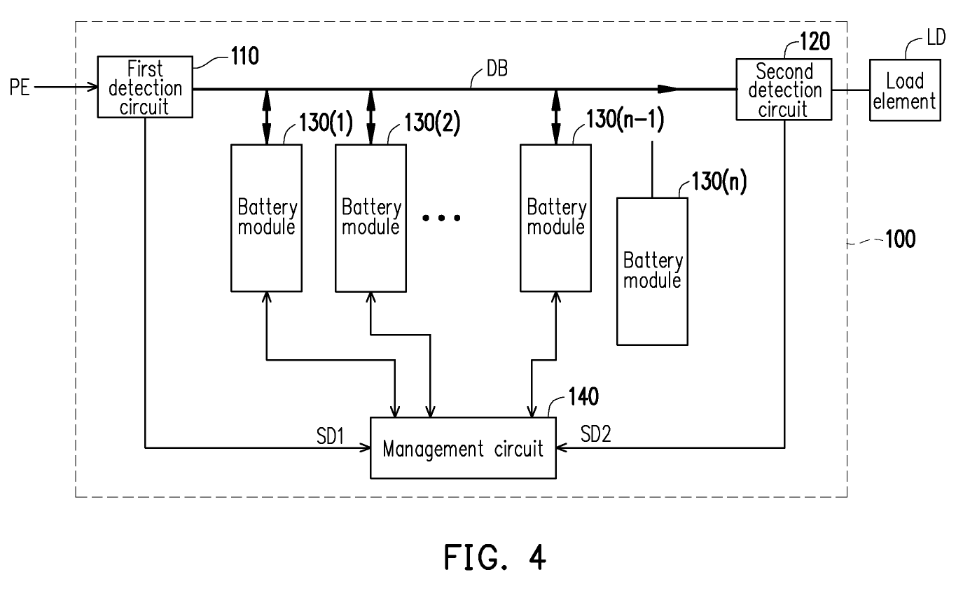

Referring to FIG. 4, FIG. 4 is a schematic diagram illustrating the operation of the DC power supply device receiving the external power source according to an embodiment of the disclosure. In this embodiment, in response to the load status indicating that the load power of the DC power bus DB is lower than the external power of the external power source PE, the management circuit 140 uses the external power source PE to power the load element LD connected to the DC power bus DB and the battery modules 130(1) to 130(n-1).

In this embodiment, in response to the load status indicating that the load power of the DC power bus DB is lower than the external power of the external power source PE, the management circuit 140 powers the load element LD connected to the DC power bus DB based on the remaining battery of the battery modules 130(1) to 130(n-1). In other words, in response to the load power of the DC power bus DB being lower than the external power of the external power source PE, the external power source PE and the remaining battery of the battery modules 130(1) to 130(n-1) power the load element LD connected to the DC power bus DB. In this embodiment, in response to the remaining battery of one of the battery modules 130(1) to 130(n-1) being lower than a critical charge, said one of the battery modules 130(1) to 130(n-1) stops powering.

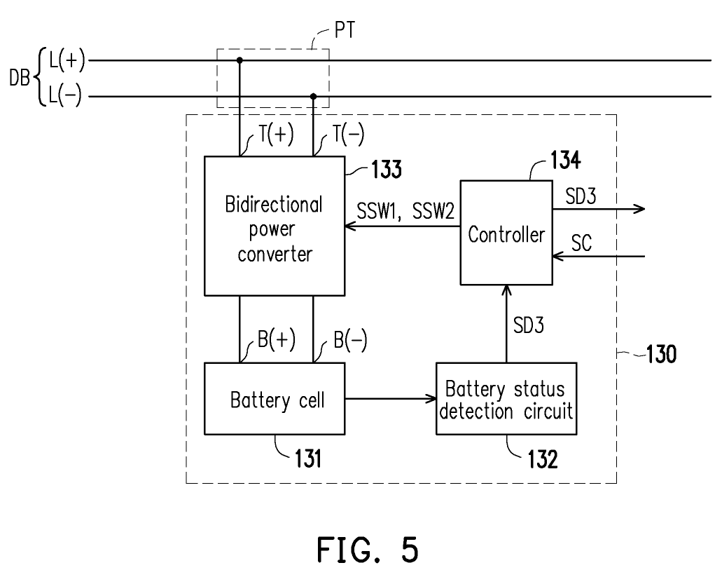

Referring to FIG. 1 and FIG. 5, FIG. 5 is a schematic diagram of a battery module according to an embodiment of the disclosure. In this embodiment, the battery module 130 includes a battery cell 131, a battery status detection circuit 132, a bidirectional power converter 133, and a controller 134. The battery status detection circuit 132 is coupled to the battery cell 131. The battery status detection circuit 132 detects the status of the battery cell 131. The bidirectional power converter 133 is coupled to the battery cell 131. The controller 134 is coupled to the bidirectional power converter 133 and the battery status detection circuit 132. In response to the bidirectional power converter 133 being connected to the DC power bus DB, the controller 134 controls the bidirectional power converter 133 to perform one of charging and discharging the battery cell 131.

In this embodiment, the DC power bus DB includes a plurality of connection ports PT. In response to the bidirectional power converter 133 being connected to one of the connection ports PT of the DC power bus DB, the positive connection terminal T(+) of the bidirectional power converter 133 is connected to the positive power supply line L(+) of the DC power bus DB via the connection port PT. The negative connection terminal T(-) of the bidirectional power converter 133 is connected to the negative power supply line L(-) of the DC power bus DB via the connection port PT.

In this embodiment, the battery status detection circuit 132 may detect the remaining battery, temperature, voltage value, and current value of the battery cell 131 to generate a detection signal SD3. In response to the bidirectional power converter 133 being connected to one of the connection ports PT of the DC power bus DB, the controller 134 communicates with the management circuit 140 to perform one of charging and discharging of the battery module 130.

In this embodiment, the controller 134 may provide the detection signal SD3 to the management circuit 140. The management circuit 140 may control the controller 134 using a control signal SC, so that the controller 134 performs operations such as discharging, charging, or disabling based on the control signal SC.

During the period when the battery module 130 is performing discharging, the controller 134 may determine the remaining battery, temperature, voltage value, and current value of the battery cell 131 based on the detection signal SD3. For example, in response to one of the remaining battery, voltage value, and current value of the battery cell 131 being too low, the controller 134 stops the battery module 130 from performing discharging. For example, in response to one of the temperature and current value of the battery cell 131 being too high, the controller 134 controls the bidirectional power converter 133 to reduce the discharging power of the battery module 130 or stop the battery module 130 from performing discharging.

Further, the controller 134 may determine whether the battery cell 131 has an abnormality or aging based on the detection signal SD3. In response to the battery cell 131 being abnormal or aging, the battery module 130 may be detached from the DC power bus DB for maintenance. As such, the cost of maintenance may be reduced. The convenience of maintenance may be improved.

In this embodiment, the controller 134 is, for example, a central processing unit, or other programmable general-purpose or special-purpose microprocessor, digital signal processor, programmable controller, application specific integrated circuit, programmable logic device, or other similar device, or a combination of these devices, which may load and execute computer programs.

In this embodiment, the battery cell 131 may be an electrical energy storage component well known to those skilled in the art, such as an aluminum-ion battery, a lithium-ion battery, and the like.

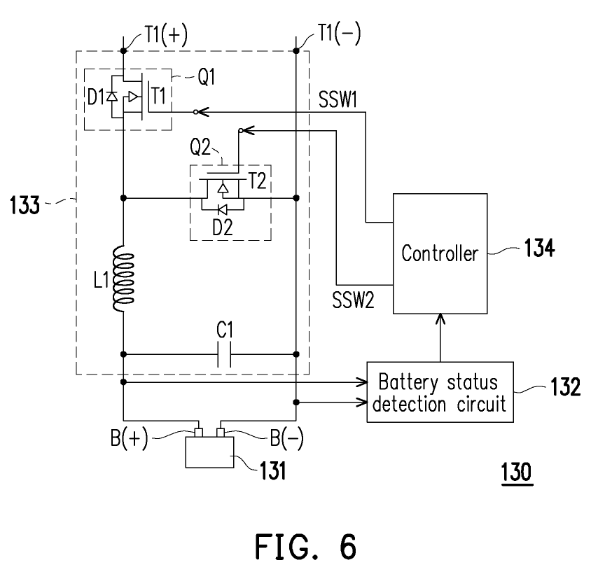

Referring to FIG. 6, FIG. 6 is a schematic diagram of a battery module according to an embodiment of the disclosure. In this embodiment, the battery module 130 includes a battery cell 131, a battery status detection circuit 132, a bidirectional power converter 133, and a controller 134. The bidirectional power converter 133 includes a capacitor C1, an inductor L1, a first power switch Q1, and a second power switch Q2. The capacitor C1 is coupled between a positive power supply terminal B(+) of the battery cell 131 and a negative power supply terminal B(-) of the battery cell 131. A first terminal of the inductor L1 is coupled to the positive power supply terminal B(+) of the battery cell 131. A first terminal of the first power switch Q1 is coupled to a second terminal of the inductor L1. A second terminal of the first power switch Q1 is coupled to a positive connection terminal T(+) of the bidirectional power converter 133. A control terminal of the first power switch Q1 is coupled to the controller 134 to receive a first switch signal SSW1. A first terminal of the second power switch Q2 is coupled to the second terminal of the inductor L1. A second terminal of the second power switch Q2 is coupled to a negative connection terminal T(-) of the bidirectional power converter 133 and the negative power supply terminal B(-) of the battery cell 131. A control terminal of the second power switch Q2 is coupled to the controller 134 to receive a second switch signal SSW2.

In this embodiment, the first power switch Q1 includes a diode D1 and a power transistor T1. An anode of the diode D1 is coupled to the first terminal of the first power switch Q1. A cathode of the diode D1 is coupled to the second terminal of the first power switch Q1. A first terminal of the power transistor T1 is coupled to the first terminal of the first power switch Q1. A second terminal of the power transistor T1 is coupled to the second terminal of the first power switch Q1. A control terminal of the power transistor T1 is coupled to the control terminal of the first power switch Q1.

The second power switch Q2 includes a diode D2 and a power transistor T2. An anode of the diode D2 is coupled to the second terminal of the second power switch Q2. A cathode of the diode D1 is coupled to the first terminal of the second power switch Q2. A first terminal of the power transistor T2 is coupled to the first terminal of the second power switch Q2. A second terminal of the power transistor T2 is coupled to the second terminal of the second power switch Q2. A control terminal of the power transistor T2 is coupled to the control terminal of the second power switch Q2.

In this embodiment, the power transistors T1 and T2 are respectively implemented by, for example, N-type transistors (the disclosure is not limited to the types of the power transistors T1 and T2).

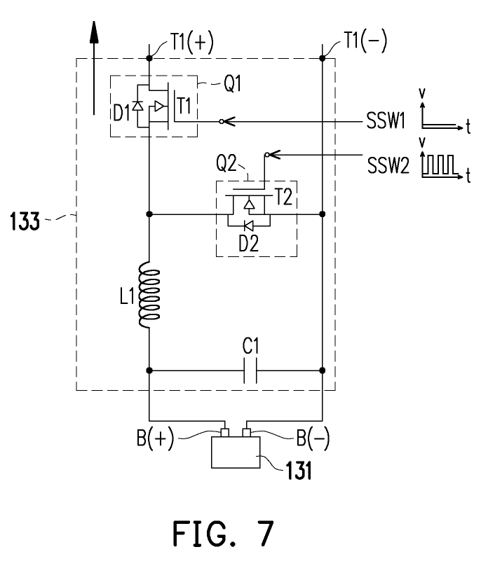

Referring to FIG. 6 and FIG. 7, FIG. 7 is a schematic diagram illustrating an operation of the battery module according to an embodiment of the disclosure. In this embodiment, in response to the bidirectional power converter 133 being assembled to the DC power bus DB and the battery cell 131 performing discharge, the power transistor T1 is turned off based on the first switch signal SSW1. The second power switch Q2 performs switch operation based on the duty cycle of the second switch signal SSW2. The duty cycle is greater than 0. In this embodiment, the electrical energy provided by the bidirectional power converter 133 is determined by the duty cycle of the second switch signal SSW2.

In response to the bidirectional power converter 133 being assembled to the DC power bus DB and the battery cell 131 performing discharge, the power transistor T1 is turned off based on the low voltage value of the first switch signal SSW1. The power transistor T2 performs switch operation based on the duty cycle of the second switch signal SSW2. The power transistor T2 is turned on based on the high voltage value of the second switch signal SSW2 to store energy in the inductor L1. The power transistor T2 is turned off based on the high voltage value of the second switch signal SSW2 to release the electrical energy stored in the inductor L1. Thus, in response to the bidirectional power converter 133 being assembled to the DC power bus DB and the battery cell 131 performing discharge, the electrical energy stored in the inductor L1 is provided to the DC power bus DB via the diode D1. Thus, in this embodiment, the duty cycle of the second switch signal SSW2 is positively correlated or proportional to the electrical energy provided by the bidirectional power converter 133.

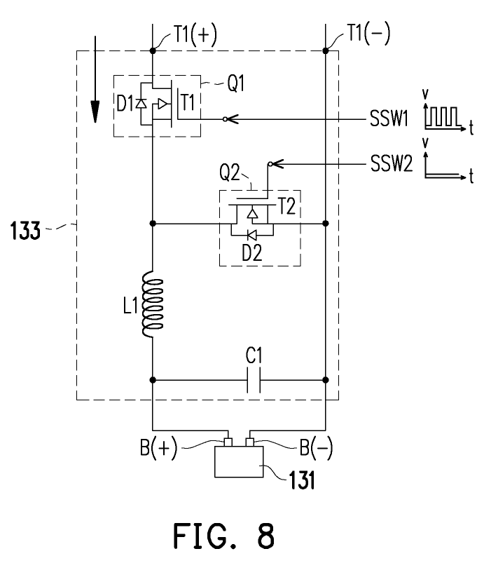

Referring to FIG. 6 and FIG. 8, FIG. 8 is a schematic diagram illustrating an operation of the battery module according to an embodiment of the disclosure. In this embodiment, in response to the bidirectional power converter 133 being assembled to the DC power bus DB and the battery cell 131 performing charge, the second power switch Q2 is turned off based on the second switch signal SSW2. The power transistor T1 performs switch operation based on the duty cycle of the first switch signal SSW1. The duty cycle of the first switch signal SSW1 is greater than 0.

In this embodiment, in response to the bidirectional power converter 133 being assembled to the DC power bus DB and the battery cell 131 performing charge, the power transistor T2 is turned off based on the low voltage value of the second switch signal SSW2. Thus, the second power switch Q2 is turned off. The power transistor T1 performs switch operation based on the duty cycle of the first switch signal SSW1. Thus, the electrical energy from the DC power bus DB may charge the battery cell 131 during the period when the power transistor T1 is turned on. In this embodiment, the duty cycle of the first switch signal SSW1 is positively correlated or proportional to the power at which the battery cell 131 performs charge.

In summary, the DC power supply device includes a plurality of assembled battery modules assembled to the DC power bus. In response to the DC power bus not receiving the external power source, the management circuit may dynamically adjust the power supply quantity of the plurality of assembled battery modules based on the load status. As such, the lifespan of the battery cells of the plurality of assembled battery modules may be extended. The performance of the battery cells in the battery module is not significantly reduced. Further, in response to one of the plurality of battery modules having an abnormality, the abnormal battery module may be detached from the DC power bus for maintenance. As such, the cost of maintenance may be reduced. The convenience of maintenance may be improved.

Although the disclosure has been described in detail with reference to the above embodiments, they are not intended to limit the disclosure. Those skilled in the art should understand that it is possible to make changes and modifications without departing from the spirit and scope of the disclosure. Thus, the protection scope of the disclosure shall be defined by the following claims.

What is claimed is:

1. A DC power supply device, comprising:
a DC power bus;
a first detection circuit, coupled to the DC power bus and configured to detect an external power source entering the DC power bus;
a second detection circuit, coupled to the DC power bus and configured to detect a load status at the DC power bus;
a plurality of battery modules, each detachably assembled to the DC power bus; and
a management circuit, communicating with the first detection circuit, the second detection circuit, and a plurality of assembled battery modules assembled to the DC power bus and configured to adjust a power supply quantity of the assembled battery modules based on the load status in response to the DC power bus not receiving the external power source.

2. The DC power supply device according to claim 1, wherein in response to the DC power bus not receiving the external power source and the load status indicating a heavy load, the management circuit controls the assembled battery modules to power the DC power bus.

3. The DC power supply device according to claim 1, wherein in response to the DC power bus not receiving the external power source and the load status indicating a light load, the management circuit controls one of the assembled battery modules to power the DC power bus.

4. The DC power supply device according to claim 1, wherein in response to the load status indicating that a load of the DC power bus increases and that the DC power bus is not receiving the external power source, the management circuit increases a power supply quantity of the assembled battery modules.

5. The DC power supply device according to claim 1, wherein in response to the load status indicating that a load of the DC power bus decreases and that the DC power bus is not receiving the external power source, the management circuit reduces a power supply quantity of the assembled battery modules.

6. The DC power supply device according to claim 1, wherein in response to the load status indicating that a load power of the DC power bus is lower than an external power of the external power source, the management circuit utilizes the external power source to power a load element connected to the DC power bus and the assembled battery modules.

7. The DC power supply device according to claim 6, wherein in response to the load status indicating that the load power of the DC power bus is lower than the external power of the external power source, the management circuit powers the load element based on a remaining battery of the assembled battery modules.

8. The DC power supply device according to claim 1, wherein the management circuit determines a discharge order of the assembled battery modules based on a remaining battery of the assembled battery modules.

9. The DC power supply device according to claim 1, wherein one of the battery modules comprises:
a battery cell;
a battery status detection circuit, coupled to the battery cell and configured to detect a status of the battery cell;
a bidirectional power converter, coupled to the battery cell; and
a controller, coupled to the bidirectional power converter and the battery status detection circuit and configured to control the bidirectional power converter to perform one of charging and discharging the battery cell in response to the bidirectional power converter being connected to the DC power bus.

10. The DC power supply device according to claim 9, wherein the bidirectional power converter comprises:
a capacitor, coupled between a positive power supply terminal of the battery cell and a negative power supply terminal of the battery cell;
an inductor, a first terminal of the inductor coupled to a positive power supply terminal of the battery cell;
a first power switch, a first terminal of the first power switch coupled to a second terminal of the inductor, a second terminal of the first power switch coupled to a positive connection terminal of the bidirectional power converter, and a control terminal of the first power switch coupled to the controller to receive a first switch signal; and
a second power switch, a first terminal of the second power switch coupled to a second terminal of the inductor, a second terminal of the second power switch coupled to a negative connection terminal of the bidirectional power converter, and a control terminal of the second power switch coupled to the controller to receive a second switch signal.

11. The DC power supply device according to claim 10, wherein in response to the bidirectional power converter being assembled to the DC power bus, a positive connection terminal of the bidirectional power converter is connected to a positive power supply line of the DC power bus, and a negative connection terminal of the bidirectional power converter is connected to a negative power supply line of the DC power bus.

12. The DC power supply device according to claim 10, wherein the first power switch comprises:
a diode, an anode of the diode coupled to a first terminal of the first power switch, and a cathode of the diode coupled to a second terminal of the first power switch; and
a power transistor, a first terminal of the power transistor coupled to a first terminal of the first power switch, a second terminal of the power transistor coupled to a second terminal of the first power switch, a control terminal of the power transistor coupled to a control terminal of the first power switch.

13. The DC power supply device according to claim 12, wherein:
in response to the bidirectional power converter being assembled to the DC power bus and the battery cell performing discharging, the power transistor is turned off based on the first switch signal, the second power switch performs switch operation based on a duty cycle of the second switch signal, and
the duty cycle is greater than 0.

14. The DC power supply device according to claim 13, wherein electrical energy provided by the bidirectional power converter is determined by the duty cycle.

15. The DC power supply device according to claim 13, wherein in response to the bidirectional power converter being assembled to the DC power bus and the battery cell performing discharging, electrical energy stored in the inductor is provided to the DC power bus via the diode.

16. The DC power supply device according to claim 12, wherein:
in response to the bidirectional power converter being assembled to the DC power bus and the battery cell performing charging, the second power switch is turned off based on the second switch signal, the power transistor performs switch operation based on a duty cycle of the first switch signal, and
the duty cycle is greater than 0.
